(19) United States
(12) Patent Application Publication
(10) Pub. No.: US 2011/0283605 A1
(43) Pub. Date: Nov. 24, 2011

(54) DETOXIFIED AND TRANSESTERIFIED ARGEMONE OIL AS BIO-ADDITIVE

(76) Inventor: Premananda DAS, Mumbai (IN)

(21) Appl. No.: 13/110,138

(22) Filed: May 18, 2011

(30) Foreign Application Priority Data
May 18, 2010 (IN) 1570/MUM/2010

(51) Int. Cl. C10L 1/19

(52) U.S. Cl. 44/388

(57) ABSTRACT

Disclosed herein is the detoxified and transesterified Argemone oil, for used as bio-additive to petroleum diesel and process for preparation thereof.

### TECHNICAL FIELD OF THE INVENTION

The present invention relates to detoxified and transesterified Argemone oil for use as bio-additive to petroleum diesel. This invention further relates to an improved, economically viable process for detoxification and transesterification of Argemone oil.

### BACKGROUND AND PRIOR ART

Industrial revolution and depleting petroleum resources have impacted crude oil prices. Further, increasing uncertainties about natural resources and constrains in global energy production and supply has led to search and research for viable alternatives. It is therefore prudent and urgent to look for alternate economically viable renewable and sustainable resources from nature with high yield and affordable prices. In this perspective, considerable attention has been drawn towards the production of bio-diesel as diesel substitute. However, a major hurdle towards widespread commercialization of bio-diesel is the high price of bio-diesel.

Changing fuel parameters can cause unforeseen wear, deposit of combustion problem with corresponding impacts on engine performance and emission. Many performance concerns can be addressed with additive treatment. Fuel additives can selectively restore specific performance characteristic of the fuel.

Due to the fact that plants/herbs, vegetable oils and animal fats are renewable biomass sources and due to its environmental benefits, the inventor of the present invention therefore decided to explore the use of plants/herbs for extracting oil as bio-additive to the petroleum diesel.

Among the known sources, Palm oil has been widely accepted and used conventionally. However, being edible oil the diversion for commercial use is unacceptable.

Argemone is a genus of flowering plants in the family Papaveraceae. It contains 30 to 32 species, found in Mexico and now widely naturalized in the United States, India and Ethiopia. It is an annual herb with bright yellow sap, is drought tolerant and non-browsed. The seeds contain 22-36% of pale yellow non-edible oil, called Argemone oil or Katkar oil.

In the above context, it is therefore the object of the present invention to use Argemone oil to produce bio-additive which is economic, commercially viable, enhances the efficacy of the fuel liquids and reduces air pollution.

### SUMMARY OF THE INVENTION

In an aspect, the present invention provides the detoxified and transesterified oil obtained from seeds of Argemone for use as bio-additive to petroleum diesel.

In another aspect, the present invention provides a process for preparation of detoxified and transesterified oil obtained from seeds of Argemone, as bio-additive to petroleum diesel.

### DETAILED DESCRIPTION OF DRAWINGS

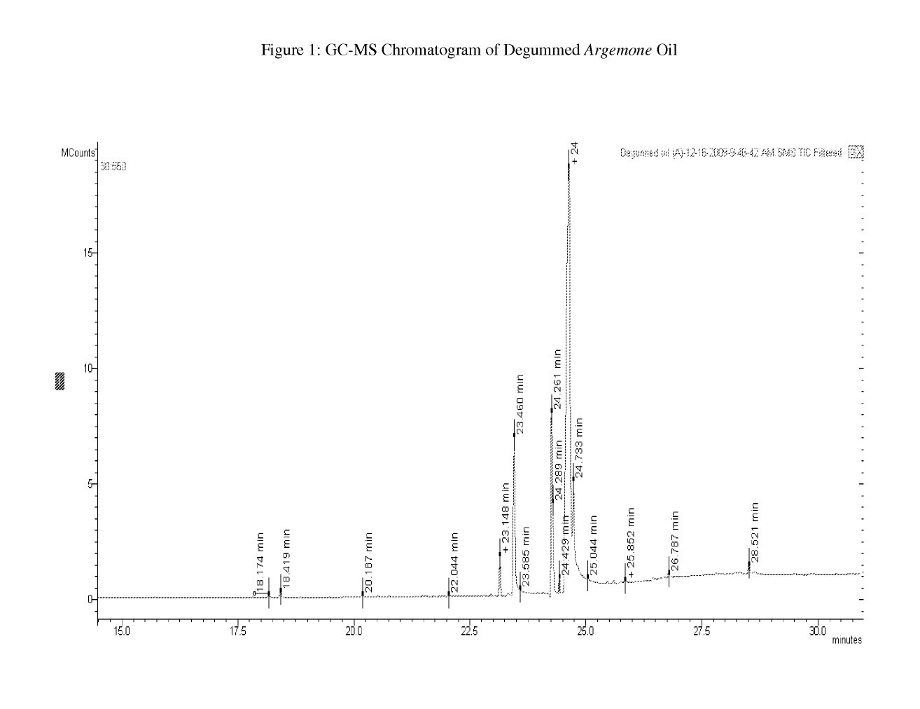

FIG. 1 depicts the GC-MS of Degummed Argemone Oil.

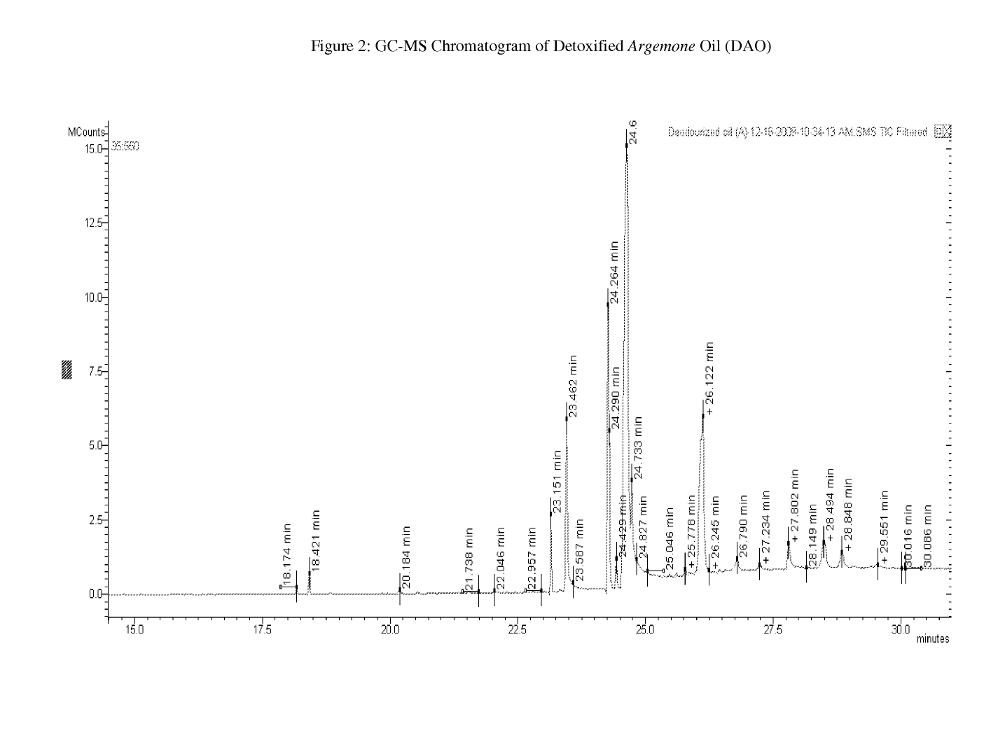

FIG. 2 depicts the GC-MS of Detoxified Argemone Oil (DAO).

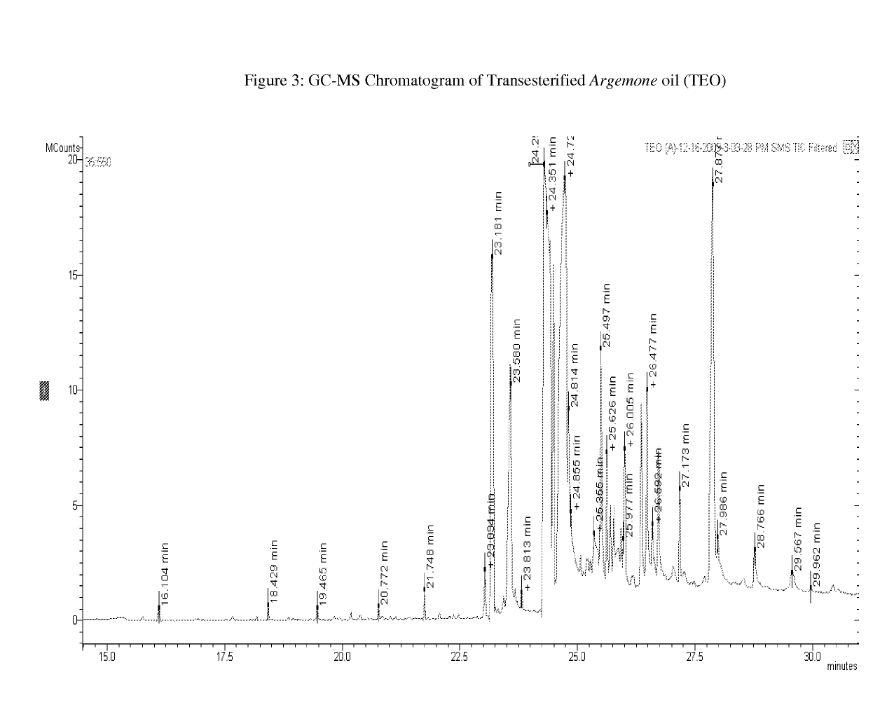

FIG. 3 depicts the GC-MS of Transesterified Oil of Argemone (TEO).

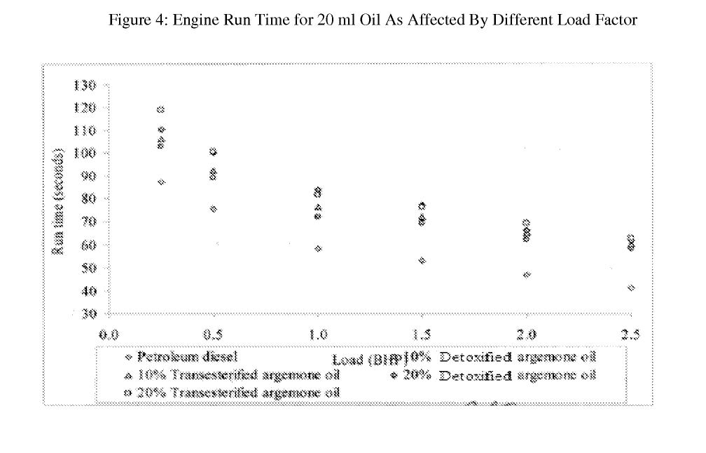

FIG. 4 illustrates the engine run times for 20 ml oil as affected by different load factor.

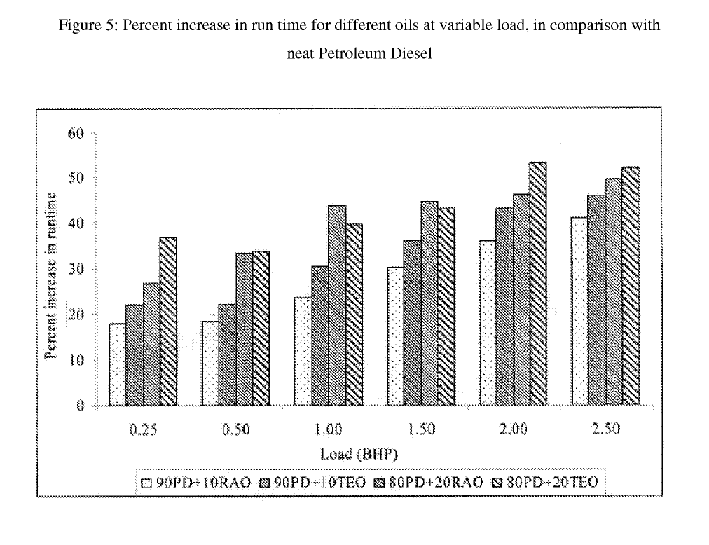

FIG. 5 illustrates percent increase in run time for different oils at variable load, in comparison with neat Petroleum Diesel.

### DETAILED DESCRIPTION OF THE INVENTION

The invention will now be described in detail in connection with certain preferred and optional embodiments, so that various aspects thereof may be more fully understood and appreciated. The embodiments as described are not limiting or restricting the scope of the invention.

For the purpose of this invention, “DAO” refers to Detoxified Argemone Oil and “TEO” refers to Transesterified oil and “PD” refers to Petroleum Diesel.

The present invention relates to bio-additive obtained from Argemone oil and to a process for the preparation thereof. Accordingly, the present invention provides detoxified and transesterified Argemone oil extracted from the seeds of Argemone by a process which is simple, economical and which gives high yields of bio additive.

The extraction of Argemone oil, its economic benefits along with favorable emission and pollution parameters is evaluated by the present inventor. The bio-additive so obtained is with high efficiency, and better biodegradability. Argemone oil is highly economic, eco-friendly and an efficient bio-additive which is economically accessible without any seasonal restriction. By undertaking cultivation on large scale, the availability can be assured.

Argemone seeds are harvested from Argemone plants cultivated at the experimental garden at the Science Foundation for Tribal and Rural Resource Development, Orissa. The seed are collected, dried and processed to obtain crude oil by standard method. The crude oil may contain the toxic alkaloids sanguinarine and dihydrosanguinarine, four quaternary isoquinoline alkaloids such as dehydrocorydalmine, jatrorrhizine, columbamine, and oxyberberine.

The present invention discloses a detoxified and transesterified oil of Argemone, which has been characterized by GC-MS (Gas Chromatography-Mass Spectroscopy). The modified and processed oil is useful as bio-additive to petroleum diesel.

In an embodiment, the present invention discloses a process of extraction, modification as well as characterization of the detoxified and transesterified oil of Argemone.

In a preferred aspect, the present invention discloses a process for preparation of detoxified and transesterified Argemone oil as bio-additive which is described herein as follows:
a) degumming of crude Argemone oil by treating with mineral acid and lower alcohol to remove alkaloid and gums;
b) detoxifying the above degummed oil by treating with 0.1% aqueous NaOH solution to obtain alkaloid free or detoxified Argemone oil with high purity, and
c) transesterifying detoxified Argemone oil of step (b), by successive treatment with acid and alkali in presence of methanol to obtain transesterified Argemone oil.

According to step (a), the crude Argemone oil is treated with a mineral acid selected from sulphuric acid, nitric acid, hydrochloric acid, Pertechnetic acid (HTcO4), phosphoric acid; preferably ortho-phosphoric acid (H3PO4) and a lower alcohol such as methanol, butanol, isopropanol etc., preferably methanol. The mixture is allowed to stand overnight, the oil is separated from alcoholic layer and precipitated compounds are filtered. The lower layer consisting of alcohol and the mineral acid is recycled several times to obtain degummed Argemone oil.

According to step (a), after degumming, the oil is kept overnight with 0.1% aqueous sodium hydroxide solution, the aqueous portion is discarded and the oil is washed twice with water to remove residual alkali. The oil is thereafter heated in a water bath at 100° C. for 1 hour, passed through warmed anhydrous Na₂SO₃ or centrifuged to remove moisture from oil. The oil obtained is alkaloid free Argemone oil or Detoxified Argemone Oil (DAO).

Referring to step (c), the degummed and detoxified oil is successively esterified with acid and alkali in presence of methanol. Since, the reactivity of methoxide radicals is higher than that of ethoxide radicals; methanol was used for transesterification of Argemone oil. Accordingly, the degummed and detoxified (alkaloid) free oil is mixed with sulphuric acid and methanol in the proportion of 50:10:1 (oil:MeOH:H₂SO₄, v/v/v) for esterification. After completion of the process, the lower layer is discarded and oil is neutralized with methanolic caustic soda solution and methanol is recovered from the oil. The neutral oil is further mixed with sodium hydroxide and methanol in a ratio of oil:alkali:methanol (25:0.2:5) for 4 hrs at 50° C. After transesterification, the oil is separated, washed with water to remove impurities. The resultant oil sample—Transesterified Oil of Argemone (TEO) is stored for further analysis.

From the aforesaid improved process higher yield of detoxified and transesterified Argemone oil in substantially pure form is achieved which is at least of 85 to 90%.

The laboratory process described herein can be scaled up to industrial requirements by conventional methods of extraction, modification and in-process characterizing in commercial scale.

The compounds obtained in degummed oil, detoxified oil and tranesterified oil are given below in Table 1, 2 and 3 respectively.

Further, the compounds obtained in degummed oil, detoxified oil and tranesterified oil characterized by GC-MS (Gas Chromatography-Mass Spectroscopy) is given in FIGS. 1, 2 and 3 respectively.

TABLE 1
COMPOUNDS FOUND IN DEGUMMED OIL

| Sr. No. | Name | Formula | RT | Synonyms | MW |
|---|---|---|---|---|---|
| 1. | Methyl (2Z)-2-decene-4,6- | C₁₁H₁₂O₂ | 20.188 | Lachnophyllum | 176 |
| | diynoate | | | ester, cis | |
| 2. | Dodecanoic acid | C₁₂H₂₄O₂ | 20.538 | Neo-fat 12-43/ | 200 |
| | | | | Vulvic acid | |
| 3. | Methyl 12-methyltridecanoate | C₁₅H₃₀O₂ | 21.739 | Methyl isomyristate | 242 |
| 4. | Tetradecanoic acid | C₁₄H₂₈O₂ | 22.044 | Myristic acid | 228 |
| 5. | Hexadecanoic acid, methyl | C₁₇H₃₄O₂ | 23.159 | Methyl palmitate | 270 |
| | ester | | | | |
| 6. | 9,12-Octadecadienoic acid | C₁₉H₃₄O₂ | 24.263 | Methyl linoleate | 294 |
| | (Z,Z)-, methyl ester | | | | |
| 7. | Octadecanoic acid, methyl | C₁₉H₃₈O₂ | 24.431 | Methyl stearate | 298 |
| | ester | | | | |
| 8. | 9,12-Octadecadienoic acid | C₁₈H₃₂O₂ | 24.641 | Linoleic acid | 280 |
| | (Z,Z)- | | | | |
| 9. | Octadecanoic acid | C₁₈H₃₆O₂ | 24.734 | Stearic acid | 284 |
| 10. | Methyl (7E,10E,13E)-7,10, | C₂₁H₃₆O₂ | 25.047 | Methyl eicosa-7, | 320 |
| | 13-icosatrienoate | | | 10,13 trienoate | |
| 11. | Methyl icosanoate | C21H42O2 | 25.604 | Methyl arachisate/ | 326 |
| | | | | Methyl eicosanoate | |
| 12. | n-Eicosanoicacid | C20H40O2 | 25.856 | Arachidic acid | 312 |

TABLE 2
COMPOUNDS FOUND IN DETOXIFIED OIL

| Sr. | | | | | |
|---|---|---|---|---|---|
| No. | Name | Formula | RT | Synonyms | MW |
| 1. | 9-octadecenoic | C₁₉H₃₆O₂ | 24.300 | Methyl oleate | 296 |
| | acid (Z)-, methyl | | | | |
| | ester | | | | |
| 2. | Ergost-5-en-3- | C₂₈H₄₈O | 26.796 | Campesterol | 400 |
| | 01, (3a,24R)- | | | | |
| 3. | Stigmasta-5,22- | C₂₉H₄₈O | 27.228 | Stigmasterol | 412 |
| | dien-3-01,(3a,22E)- | | | | |
| 4. | Stigmast-5-en-3- | C₂₉H₅₀O | 28.492 | τ-Sitosterol | 414 |
| | 01, (3a,24S)- | | | | |
| 5. | Stigmasta-5,24(28)- | C₂₉H₄₈O | 28.850 | Isofucosterol | 412 |
| | dien-3-01, (3a,24Z)- | | | | |

The sterols found in detoxified oil for edible use such as Campesterol, Stigmasterol, τ-Sitosterol and Isofucosterol are recommended component of edible oil.

TABLE 3
COMPOUNDS FOUND IN TRANESTERIFIED OIL

| Sr. | | | | | |
|---|---|---|---|---|---|
| No. | Name | Formula | RT | Synonyms | MW |
| 1. | Methyl 10- | C13H26O2 | 20.184 | Undecanoic | 214 |
| | methylundecanoate | | | acid, 10- | |
| | | | | methyl-, | |
| | | | | methyl ester | |
| 2. | 9-Hexadecenoic | C17H32O2 | 23.036 | Methyl | 268 |
| | acid, methyl | | | palmitoleate | |
| | ester, (Z)- | | | | |
| 3. | Methyl | C19H32O2 | 25.192 | 6,9,12- | 292 |
| | (6E,9E,12E)- | | | Octadeca- | |
| | 6,9,12 | | | trienoic acid, | |
| | octadecatrienoate | | | methyl ester | |
| 4. | 9-0ctadecenoic | C19H36O3 | 25.496 | Methyl | 312 |
| | acid, 12-hydroxy-, | | | ricinoleate | |
| | methyl ester, | | | | |
| | [R—(Z)]- | | | | |

The detoxified oil and transesterified oil obtained from the above process increases the efficiency of engine, decreases smoke percent and concentration of greenhouse gases such as carbon monoxide, carbon dioxide and nitrogen oxide as given in Table 5. The Engine run time for 20 ml oil at different load factor is shown in FIG. 4. Results reveals that engine run time per unit amount of petroleum diesel decreased with increasing load on engine, which in turn increased on addition of bio-additive of the current invention. Moreover, the efficiency of bio-additive added Petroleum Diesel (PD) over neat PD increases with increasing load on engine as exemplified by the percent increase in run time for different oils in FIG. 5.

Having described the invention with reference to certain preferred embodiments, other embodiments will become apparent to one skilled in the art from consideration of the specification. The invention is further defined by reference to the following non-limiting examples describing in detail the methods of preparation and use of the invention. It will be apparent to those skilled in the art that any modifications, both to materials and methods, may be practiced without departing from the scope of the invention.

### EXAMPLES

### Example 1

### Degumming of Argemone oil (Removal of Alkaloids and Gums)

The crude Argemone oil was treated with methanolic H₃PO₄ to remove alkaloid and gum from it. 25 ml methanolic o-phosphoric acid solution (12% v/v) was homogenized with 100 ml crude oil and allowed to stand for overnight. Thereafter, the oil was separated from methanol layer and precipitated compounds are filtered thought silica gel (60-120 mesh) under suction. The lower layer consisting of methanol and phosphoric acid is recycled three times for degumming Argemone oil. This makes the process economically more viable and attractive. 91.74% of degummed oil is obtained.

### Example 2

### Detoxification

After degumming, the oil was kept overnight with 0.1% aqueous sodium hydroxide solution, the aqueous portion was discarded and the oil was washed twice with water to remove residual alkali. The oil was thereafter heated in a water bath at 100° C. for 1 hour and then passed through warmed anhydrous Na₂SO₃ or the oil was centrifuged at 10,000 rpm for 15 mins to remove moisture from oil. HPTLC investigation proved absence of toxic compounds and was marked as alkaloid free Argemone oil or Detoxified Argemone Oil (DAO). 89.59% of detoxified oil is obtained.

### Example 3

### Two-Step Transesterification

Since, the reactivity of methoxide radicals is higher than that of ethoxide radicals, methanol was used for transesterification of Argemone oil. Degummed and alkaloid-free oil was mixed with sulphuric acid and methanol in the proportion of 50:10:1 (oil:MeOH:H₂SO₄, v/v/v) and stirred mechanically at 200 rpm at 60° C. for 3 hrs for esterification. After completion of the process, the lower layer was discarded and oil was neutralized with methanolic costic soda solution and methanol was recovered from oil. The neutral oil was then mixed with sodium hydroxide and methanol in a ratio of oil:alkali:methanol (25:0.2:5) and stirred well mechanically at 200-250 rpm for 4 hrs at 50° C. After transesterification, the oil was separated from lower layer by separating funnel or by centrifugation and washed with water twice to remove impurities. The resultant oil sample Transesterified Oil of Argemone (TEO) was stored for further analysis. 86.42% of transesterified oil is obtained.

### Example 4

### Physical Properties of Detoxified and Transesterified Oil

Specific gravity of detoxified and transesterified oil and petroleum diesel was measured using specific gravity bottle. Cloud point, acid value and iodine value of these oils were estimated by ASTM D2500, AOCS Te la-64 and AOCS Tg 1-64 methods, respectively. (Table 4)

TABLE 4
Physical Properties of Oils

| | | | Acid value | Iodine | |
|---|---|---|---|---|---|
| | | | (mg | value | Viscosity |
| | Specific | Cloud | NaOH/ | (g iodine/ | (×10⁴ |
| | gravity | Point ° C. | g oil) | 100 g oil) | centipoise) |
| Crude Oil (CO) | 0.928 | 7 | 19.517 | 352.92 | 37.85 |
| Detoxified | 0.904 | −2 | 2.044 | 190.35 | 8.266 |
| Argemone | | | | | |
| Oil (DAO) | | | | | |
| Transesterified | 0.888 | −1 | 1.251 | 134.69 | 5.181 |
| Oil (TEO) | | | | | |
| Petroleum | 0.831 | −4 | 0.367 | 70.50 | 3.64 |
| Diesel (PD) | | | | | |

### Example 5

### Gas Chromatography-Mass Spectroscopy Analysis of Oil

Fatty acid components of esters were identified using Gas Chromatography-Mass Spectroscopy (varian, gas-chromatography 4000 Ion Trap mass spectroscopy) equipped with VF 5-MS (30 m×0.25 m ID×0.25 μm df) column. Helium was used as carrier gas at 1 ml mil⁻¹ flow rate. The temperatures of both injector and detector were set to 270° C. The following oven temperature programme was used: Initially the temperature was retained at 45° C. for 1 min, the temperature was raised from 45° C. to 55° C. at 1° C. min⁻¹ increment, again raised from 55° C. to 290° C. at 15° C. min⁻¹ increments and finally kept for 5 min at 290° C. Total run time for each sample was 31 minutes. Injection: 1 μl split on 100 ml; Liner: Gooseneck Fritted liner 3.4 mm, 1079 injector at 270° C. GC-MS chromatograms of degummed oil, detoxified Oil (DAO) and transesterified oil (TEO) are represented in FIG. 1, FIG. 2 and FIG. 3 respectively.

### Example 6

### Engine Test

Engine run time for 20 ml oil at different load factor is shown in FIG. 4. Results reveals that engine run time per unit amount of petroleum diesel decreased with increasing load on engine, which in turn increased on addition with bio-additive. This indicates the superiority/effectiveness of both the biofuels to increase diesel engine efficiency.

Further, percent increase in run time for different oils (FIG. 5) also shows that the efficiency of bio-additive added Petroleum Diesel (PD) over neat PD increases with increasing load on engine. Data suggested that maximum 52% increment in run time was recorded when 20% TEO was mixed with PD. But 20% DAO addition registered up to 48% increase in run time of diesel engine and upto 41% increase in run time was observed when engine was run only 10% DAO added PD.

### Exhaust Emissions

The emissions of carbon monoxide, unburned hydrocarbon (UHC) and nitrogen oxide were examined (Table 5). Pollution parameters of emitted smoke were much reduced due to addition of biofuels. Pollution parameters of emitted smoke were reduced due to addition of biofuels in PD. 10% addition of DAO and TEO and 20% addition of DAO in PD decreased the smoke percent and concentration of unburned hydrocarbon, CO, CO₂, NOx in smoke as compared to PD application. In case of 20% TEO added PD, though smoke percent and concentration of CO₂ and NOx decreased, it increased UHC and CO content in emitted smoke.

TABLE 5
Smoke percent and concentration of greenhouse gases in emitted gas
as affected by different fuel

| | | | Carbon | Carbon | Nitrogen |
|---|---|---|---|---|---|
| | Smoke % | Hydrocarbons | Monoxide | dioxide | Oxides |
| 100 PD | 44 ± 6 | 53 ± 6 | 0.29 ± 0.03 | 16.16 ± 2.07 | 0.34 ± 0.09 |
| 90 PD + 10 DAO | 37 ± 2 | 37 ± 4 | 0.22 ± 0.05 | 9.73 ± 1.67 | 0.18 ± 0.04 |
| 80 PD + 20 DAO | 34 ± 3 | 22 ± 3 | 0.16 ± 0.03 | 6.44 ± 1.29 | 0.12 ± 0.02 |
| 70 PD + 30 DAO | 40 ± 5 | 29 ± 2 | 0.20 ± 0.04 | 8.91 ± 1.27 | 0.15 ± 0.04 |
| 60 PD + 40 DAO | 33 ± 3 | 33 ± 5 | 0.27 ± 0.04 | 5.08 ± 1.38 | 0.09 ± 0.01 |

The invention described herein, the compound found in detoxified oil, as well as transesterified oil and their characteristic as well as the processes of preparation, as described herein are not limiting and may be treated as extending to equivalents and other characterization processes as understood by a person skilled in the art including example as described herein above.

The degummed, detoxified and transesterified oil of Argemone, used as bio-additive to petroleum diesel is obtained from oil of Argemone, by the aforementioned process, wherein, the so obtained degummed, detoxified and transesterified oil are characterized by GC-MS and are shown in FIG. 1, FIG. 2 and FIG. 3 respectively. The compounds found in the degummed, detoxified and transesterified oil is described in Table 1, Table 2 and Table 3 respectively.

Advantages: The degummed, detoxified and transesterified oil obtained in the present invention;
Reduce heat/temperature
Save fuel/Diesel consumption
Reduces engine noise
Reduces air pollution
Engine performance smoother and give longer piston life
Applicable to Petrol and Diesel fuel Engine and Machinery
Cost effective—Cheap

1. A bioadditive for petroleum diesel, comprising a detoxified and transesterified oil obtained from seeds of Argemone.

2. The detoxified oil obtained from seeds of Argemone, as claimed in claim 1, wherein the said detoxified oil is characterized by GC-MS of FIG. 2.

3. The detoxified oil obtained from seeds of Argemone, as claimed in claim 1, wherein, said detoxified oil comprises the methyl ester of (Z)-9-octadecenoic acid; (3α,24R)-ergost-5-en-3-ol; (3α,22E)-stigmasta-5,22-dien-3-ol; (3α,24S)-stigmast-5-en-3-ol; (3α,24Z)-stigmasta-5,24(28)-dien-3-ol.

4. The transesterified oil obtained from seeds of Argemone, as claimed in claim 1, wherein the said transesterified oil is characterized by GC-MS of FIG. 3.

5. The transesterified oil obtained from seeds of Argemone, as claimed in claim 1, wherein, said transesterified oil comprises the compounds methyl 10-methylundecanoate; the methyl ester of (Z)-9-hexadecenoic acid; methyl (6E,9E,12E)-6,9,12octadecatrienoate; the methyl ester of [R—(Z)]-12-hydroxy-9-octadecenoic acid.

6. A process for preparation of detoxified and transesterified oil from the seeds of Argemone, comprising;
i. degumming of crude Argemone oil by treating with mineral acid and lower alcohol to remove alkaloid and gums;
ii. detoxifying the above degummed oil by treating with 0.1% aqueous NaOH solution to obtain alkaloid free or detoxified Argemone oil with high purity, and
iii. transesterifying detoxified Argemone oil of step (ii), by successive treatment with acid and alkali in presence of methanol to obtain transesterified Argemone oil.

7. The process for preparation of detoxified and transesterified oil as claimed in claim 6; wherein, the said mineral acid in step (i) is ortho-phosphoric acid and lower alcohol is selected from the group consisting of methanol, butanol, isopropanol.

8. (canceled)

9. (canceled)

10. The process for preparation of detoxified and transesterified Argemone oil as claimed in claim 6, wherein a yield of transesterified Argemone oil in substantially pure form is at least of 85 to 90%.

11. A method of enhancing the performance of a diesel engine, comprising:
adding the bioadditive of claim 1 to a petroleum diesel fuel to produce a fuel composition; and
running said diesel engine using said fuel composition.
